(19) United States
(12) Patent Application Publication
(10) Pub. No.: US 2026/0272020 A1
(43) Pub. Date: Sep. 17, 2026

(54) AEROSOL GENERATOR

(71) Applicant: Nicoventures Trading Limited, London (GB)

(72) Inventors: Mark POTTER, London (GB); Steven SCHENNUM, Naperville, IL (US); Matthew NETTENSTROM, Naperville, IL (US)

(21) Appl. No.: 19/168,968

(22) PCT Filed: Mar. 28, 2024
(86) PCT No.: PCT/EP2024/058596

§ 371 Date: Sep. 25, 2025

Related U.S. Application Data
(63) Continuation of application No. 18/465,701, filed on Sep. 12, 2023, now abandoned.

(30) Foreign Application Priority Data
Mar. 29, 2023 (GB) 2304638.6
Nov. 14, 2023 (GB) 2317421.2

(51) Int. Cl. A24F 40/46; A24F 40/20; A24F 40/53; A24F 40/70

(52) U.S. Cl. CPC A24F 40/46; A24F 40/20; A24F 40/70; A24F 40/53

(57) ABSTRACT

An aerosol generator is provided. The aerosol generator comprises aerosol generating material, a resistive heating layer configured to heat the aerosol generating material, and a support layer comprising a support. The resistive heating layer is on a first side of the support. The resistive heating layer comprises at least one of a first type of electrical contact and at least one of a second type of electrical contact. At least one of the first type of electrical contact and the second type of electrical contact is accessible from a second side of the support.

### CROSS-REFERENCE TO RELATED APPLICATIONS

This present application is a National Phase entry of PCT Application No. PCT/EP2024/058596, filed Mar. 28, 2024, which claims priority from Great Britain Application No. 2304638.6, filed Mar. 29, 2023, which claims priority from U.S. application Ser. No. 18/465,701, filed Sep. 12, 2023, and which claims priority from Great Britain Application No. 2317421.2, filed Nov. 14, 2023, each of which are fully incorporated herein by reference in their entireties.

### TECHNICAL FIELD

The present invention relates to an aerosol generator of an article for an aerosol provision device. The present invention also relates to an article for an aerosol provision device, an aerosol provision system, a method of forming an aerosol generator of an article for an aerosol provision device, and a blank for forming an aerosol generator of an article for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium.

### SUMMARY

According to an aspect, there is provided an aerosol generator of an article for an aerosol provision device, the aerosol generator comprising: aerosol generating material; a resistive heating layer comprising a resistive heating element configured to heat at least a portion of the aerosol generating material to generate an aerosol; the aerosol generating material being on the resistive heating layer; a first type of electrical contact; a second type of electrical contact; wherein the resistive heating element is at least a portion of an electrically conductive path between the first type of electrical contact and the second type of electrical contact; and a support, wherein the resistive heating layer is on a first side of the support between the aerosol generating material and the support; wherein at least one of the first type of electrical contact and the second type of electrical contact is accessible from a second side of the support.

In an embodiment of any of the above, the aerosol generator comprises an aerosol generating layer comprising the aerosol generating material. In an embodiment of any of the above, the aerosol generating layer is on the resistive heating layer.

In an embodiment of any of the above, the resistive heating layer is free from a fold.

In an embodiment of any of the above, the support is free from a fold.

In an embodiment of any of the above, the support comprises a support layer.

In an embodiment of any of the above, the support is electrically insulative.

In an embodiment of any of the above, the support comprises a paper or card.

In an embodiment of any of the above, the electrically conductive layer and the support layer define a substrate.

In an embodiment of any of the above, the aerosol generator comprises a laminate comprising the resistive heating layer and the support layer.

In an embodiment of any of the above, the laminate comprises the aerosol generating material.

In an embodiment of any of the above, the at least one of the first type of electrical contact and the second type of electrical contact is accessible from a second side of the support.

In an embodiment of any of the above, the at least one of the first type of electrical contact and the second type of electrical contact is exposed from a second side of the support.

In an embodiment of any of the above, the support layer comprises a card layer.

In an embodiment of any of the above, the second side is opposite the first side.

In an embodiment of any of the above, the first type of electrical contact is configured to electrically connect with a device electrical connector and the second type of electrical contact is configured to electrically connect with the device electrical connector.

In an embodiment of any of the above, the support defines an exposed contact region of the first type of electrical contact.

In an embodiment of any of the above, the exposed contact region is a first exposed contact region, and the support defines a second exposed contact region, the second exposed contact region being an exposed contact region of the second type of electrical contact.

In an embodiment of any of the above, the aerosol generating layer is a continuous aerosol generating layer.

In an embodiment of any of the above, the aerosol generating layer is a discontinuous aerosol generating layer.

In an embodiment of any of the above, the aerosol generating layer comprises a plurality of discrete aerosol generating portions.

In an embodiment of any of the above, the resistive heating element is one of a plurality of resistive heating elements.

In an embodiment of any of the above, one of the discrete aerosol generating portions is associated with a corresponding one of the plurality of resistive heating elements.

In an embodiment of any of the above, the aerosol generating layer comprises at least one of dots, strips and patches.

In an embodiment of any of the above, the resistive heating element is a first heating element and the resistive heating layer forms a second resistive heating element, each resistive heating element providing an electrically conductive path for resistive heating of a portion of the aerosol generating material to generate an aerosol at the respective portion of the aerosol generating layer.

In an embodiment of any of the above, the resistive heating layer forms an array of resistive heating elements comprising at least a first resistive heating element and a second resistive heating element.

In an embodiment of any of the above, each of the first type of electrical contact and the second type of electrical contact are configured to enable an electric current to be individually provided to each of the resistive heating elements.

In an embodiment of any of the above, the aerosol generating layer comprises a film or gel layer comprising the aerosol generating material.

In an embodiment of any of the above, the aerosol generator comprises a plurality of the first type of electrical contact, wherein each of the heating elements comprises a separate electrical contact of the first type.

In an embodiment of any of the above, the aerosol generator comprises a plurality of the second type of electrical contacts, wherein each of the resistive heating elements comprises a separate second type of electrical contact.

In an embodiment of any of the above, the aerosol generator comprises a single second type of electrical contact.

In an embodiment of any of the above, the single second type of electrical contact is shared between each of the resistive heating elements.

In an embodiment of any of the above, the resistive heating element is formed by at least one of: cutting said resistive heating layer; chemically etching said resistive heating layer; forming or pressing the resistive heating layer in the substrate; and printing said resistive heating layer.

In an embodiment of any of the above, the resistive heating layer is in the form of a foil.

In an embodiment of any of the above, the aerosol generator comprises an opening in the support so that the at least one of the first type of electrical contact and the second type of electrical contact is accessible from the second side of the support.

In an embodiment of any of the above, the opening comprises an aperture in the support.

In an embodiment of any of the above, the opening is a cutaway in the support.

In an embodiment of any of the above, the opening extends from an edge of the support.

In an embodiment of any of the above, the support comprises a first surface and a second surface of the support.

In an embodiment of any of the above, the opening extends between the first surface and a second surface of the support.

In an embodiment of any of the above, the opening is configured to receive at least a portion of a device connector of an aerosol provision device.

In an embodiment of any of the above, each of the first type of electrical contact and the second type of electrical contact is configured to be connected to the device electrical connector.

In an embodiment of any of the above, the support defines an exposed contact region of at least one of the first type of electrical contact and the second type of electrical contact.

In an embodiment of any of the above, the support defines discrete exposed contact region of each of the first type of electrical contact and the second type of electrical contact.

In an embodiment of any of the above, the opening defines a common opening between at least two exposed contact regions of the at least one of the first type of electrical contact and the second type of electrical contact.

In an embodiment of any of the above, the at least one of the first type of electrical contact and the second type of electrical contact extends at least partially through the support.

In an embodiment of any of the above, the at least one of the first type of electrical contact and the second type of electrical contact extends at least partially through the support to be exposed at the second side of the support.

In an embodiment of any of the above, the aerosol generator comprises a path in the support through which at least one of the first type of electrical contact and the second type of electrical contact extends.

In an embodiment of any of the above, the path comprises an aperture through the support, and the at least one of the first type of electrical contact and the second type of electrical contact extends around a sidewall of the aperture.

In an embodiment of any of the above, the aperture extends through the resistive heating layer.

In an embodiment of any of the above, the at least one of the first type of electrical contact and the second type of electrical contact extends around a rim of the aperture.

In an embodiment of any of the above, the at least one of the first type of electrical contact and the second type of electrical contact extends partially through the support.

In an embodiment of any of the above, the at least one of the first type of electrical contact and the second type of electrical contact extends fully through the support.

In an embodiment of any of the above, the at least one of the first type of electrical contact and the second type of electrical contact extends beyond the second side of the support.

In an embodiment of any of the above, the at least one of the first type of electrical contact and the second type of electrical contact comprises a conductive coating.

In an embodiment of any of the above, the conductive coating comprises a conductive ink.

In an embodiment of any of the above, the at least one of the first type of electrical contact and the second type of electrical contact overlaps the second side of the support.

According to an aspect there is provided an article comprising the aerosol generator of any of the above embodiments.

According to an aspect there is provided an aerosol provision system comprising an aerosol generator of any of the above embodiments and an aerosol provision device configured to receive the aerosol generator.

According to an aspect there is provided an aerosol provision system comprising an article of any of the above embodiments and an aerosol provision device configured to receive the article.

According to an aspect there is provided a method of forming an aerosol generator of an article for an aerosol provision device, the method comprising: providing a resistive heating layer; providing aerosol generating material on the resistive heating layer, wherein the resistive heating layer comprises a resistive heating element configured to heat at least a portion of the aerosol generating material to generate an aerosol; providing a first type of electrical contact; providing a second type of electrical contact; wherein the resistive heating element is at least a portion of an electrically conductive path between the first type of electrical contact and the second type of electrical contact; providing a support; providing the resistive heating layer on a first side of the support between the aerosol generating material and the support; wherein at least one of the first type of electrical contact and the second type of electrical contact is accessible from a second side of the support.

In an embodiment of any of the above, the method comprises providing an aerosol generating layer comprising the aerosol generating material.

In an embodiment of any of the above, the method comprises forming an opening in the support so that at least one of the first type of electrical contact and the second type of electrical contact is accessible from the second side of the support.

In an embodiment of any of the above, comprising forming at least one of the electrical contact of the first type and the electrical contact of the second type to extend at least partially through the support.

According to an aspect, there is provided an aerosol provision system comprising: an article and an aerosol provision device configured to receive at least a portion of the article, the article comprising: aerosol generating material; a resistive heating layer comprising a resistive heating element configured to heat at least a portion of the aerosol generating material to generate an aerosol; the aerosol generating material being on the resistive heating layer; a first type of electrical contact; a second type of electrical contact; wherein the resistive heating element forms at least a portion of an electrically conductive path between the first type of electrical contact and the second type of electrical contact; and a support, wherein the resistive heating layer is on a first side of the support between the aerosol generating material and the support; wherein at least one of the first type of electrical contact and the second type of electrical contact is accessible from a second side of the support.

In an embodiment of any of the above, the aerosol generator comprises an aerosol generating layer comprising the aerosol generating material. In an embodiment of any of the above, the aerosol generating layer is on the resistive heating layer.

In an embodiment of any of the above, the aerosol provision device comprises a device electrical connector configured to connect with the at least one of the first type of electrical contact and the second type of electrical contact.

In an embodiment of any of the above, the device electrical connector comprises a connector electrical contact configured to connect with the at least one of the first type of electrical contact and the second type of electrical contact from the second side of the support.

In an embodiment of any of the above, the device electrical connector comprises a piercing element configured to pierce a feature of the article.

In an embodiment of any of the above, the feature of the article comprises the support, and the piercing element is configured to pierce the support to electrically contact the at least one of the first type of electrical contact and the second type of electrical contact.

In an embodiment of any of the above, the connector electrical contact comprises the piercing element.

In an embodiment of any of the above, the piercing element is a pin.

In an embodiment of any of the above, the piercing element is configured to penetrate the resistive heating layer to contact the at least one of the first type of electrical contact and the second type of electrical contact.

In an embodiment of any of the above, the piercing element is configured to penetrate the support to contact the at least one of the first type of electrical contact and the second type of electrical contact.

In an embodiment of any of the above, the aerosol provision device comprises a receptacle configured to receive at least a portion of the article and the connector electrical contact is in the receptacle.

In an embodiment of any of the above, the receptacle is configured to locate at least one of the first type of electrical contact and the second type of electrical contact.

In an embodiment of any of the above, the piercing element comprises electrically conductive material.

In an embodiment of any of the above, the piercing element is movable into piercing engagement with the article.

In an embodiment of any of the above, the article is movable into piercing engagement with the piercing element.

In an embodiment of any of the above, the piercing element provides electrical power to the resistive heating layer.

According to an aspect, there is provided a blank for forming an aerosol generator of an article for an aerosol provision device, comprising: a resistive heating layer comprising a resistive heating element configured to heat at least a portion of the aerosol generating material to generate an aerosol; a first type of electrical contact; a second type of electrical contact; wherein the resistive heating element forms at least a portion of an electrically conductive path between the first type of electrical contact and the second type of electrical contact; and a support, wherein the resistive heating layer is on a first side of the support between the aerosol generating material and the support; an opening in the support so that at least one of the first type of electrical contact and the second type of electrical contact is accessible from a second side of the support.

In an embodiment of any of the above, the blank comprises an aerosol generating layer comprising aerosol generating material.

According to an aspect, there is provided an aerosol generator of an article for an aerosol provision device, the aerosol generator comprising: aerosol generating material; a resistive heating layer comprising a resistive heating element configured to heat at least a portion of the aerosol generating material to generate an aerosol; a first type of electrical contact; a second type of electrical contact; wherein the resistive heating element is at least a portion of an electrically conductive path between the first type of electrical contact and the second type of electrical contact.

According to an aspect there is provided an article comprising the aerosol generator of any of the above embodiments.

According to an aspect there is provided an aerosol provision system comprising an aerosol generator of any of the above embodiments and an aerosol provision device configured to receive the aerosol generator.

### BRIEF DESCRIPTION OF THE DRAWINGS

Various embodiments will now be described, by way of example only, with reference to the accompanying schematic drawings, in which:

FIG. 1 is a schematic perspective view of an aerosol provision system;

FIG. 2 is a schematic perspective view of an article comprising aerosol generating material of the aerosol provision system of FIG. 1;

FIG. 3 is a schematic perspective view of a first side of an aerosol generator of the article of FIG. 2;

FIG. 4 is a schematic perspective view of part of a second side of the aerosol generator of FIG. 3;

FIG. 5 is a schematic block diagram of an aerosol provision system such as the system shown in FIG. 1;

FIG. 6 is a schematic partially exploded perspective view of the article of FIG. 2, with an aerosol generator shown inverted from an assembled orientation and in a spaced relationship with other components;

FIG. 7 is a schematic cross-sectional view of another aerosol generator such as the aerosol generator shown in FIG. 3;

FIG. 8 is a schematic plan view of a heating element of the aerosol generator of FIG. 3;

FIG. 9 is a schematic plan view of a resistive heating layer of the aerosol generator of FIG. 3 with a plurality of heating elements;

FIG. 10 is a flow chart showing a method of forming an aerosol generator, such as the aerosol generator of FIG. 3;

FIG. 11 is an exploded perspective view of an aerosol generator being formed;

FIG. 12 is a schematic perspective view of a resistive heating layer of an aerosol generator being formed;

FIG. 13 is a flow chart showing a method of forming an aerosol generator, such as the aerosol generator of FIG. 3;

FIG. 14 is a flow chart showing a method of forming an aerosol generator, such as the aerosol generator of FIG. 3;

FIG. 15 is a flow chart showing a method of forming an aerosol generator, such as the aerosol generator of FIG. 3;

FIG. 16 is a schematic perspective view of a resistive heating layer of an aerosol generator being formed;

FIG. 17 is a schematic plan view of a heating element of an aerosol generator;

FIG. 18 is a schematic plan view of a heating element of an aerosol generator;

FIG. 19 is a schematic perspective view of part of an aerosol generator of the article of FIG. 2;

FIG. 20 is a schematic perspective view of a device connector of an aerosol provision device of the aerosol provision system of FIG. 1;

FIG. 21 is a schematic side view of the aerosol generating system of FIG. 1;

FIG. 22 is a flow chart showing a method of forming an aerosol generator, such as the aerosol generator of FIG. 3;

FIG. 23 is a schematic plan view of a first side of an aerosol generator of an article;

FIG. 24 is a schematic cross-section view of an aerosol generator of an article;

FIG. 25 is an exploded view of the schematic cross-section view of an aerosol generator of an article shown in FIG. 24;

FIG. 26 is a schematic cross-section view of an aerosol generator of an article;

FIG. 27 is a schematic view of an aerosol provision system; and

FIG. 28 is an enlarged view of the aerosol provision system of FIG. 26.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

In embodiments, the aerosol-generating material comprises a plurality of aerosol-generating films. In embodiments, the aerosol-generating film comprises a plurality of aerosol-generating film regions. Such plurality of aerosol-generating films and/or plurality of aerosol-generating film regions may have different properties, for example at least one of different compositions, thicknesses, density, active substances and/or flavours, one or more aerosol-former materials, and optionally one or more other functional material.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may comprise a conductor which can be heated by the passage of an electrical current through the conductor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

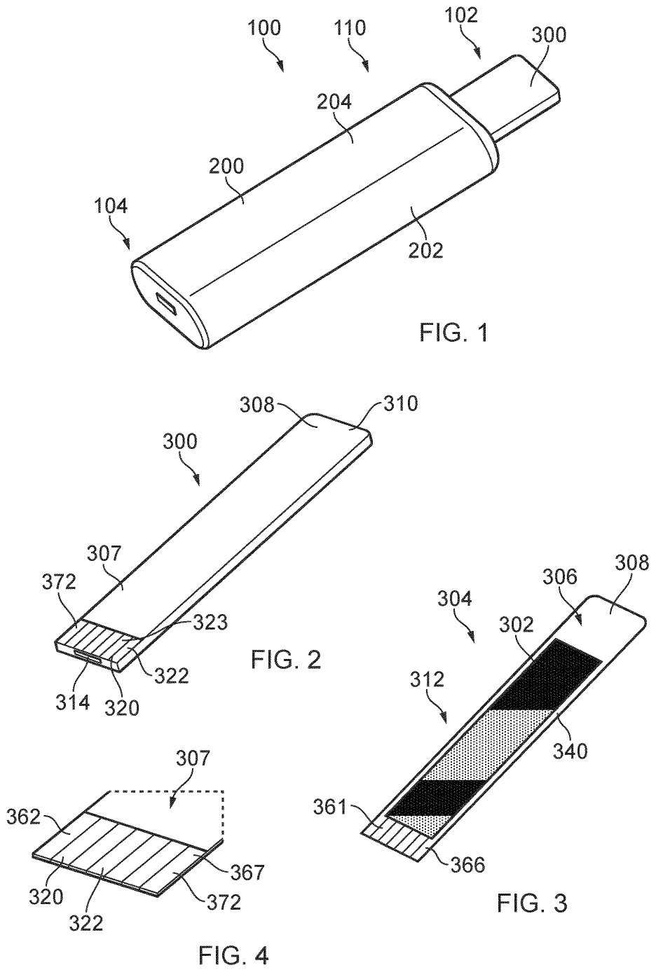

FIG. 1 shows a schematic view of an aerosol provision system 100. The aerosol provision system 100 comprises an aerosol provision device 200 and an article 300 comprising aerosol generating material 302 (refer to FIG. 3). The article 300 is shown in FIG. 2 removed from the aerosol provision device 200. An aerosol generator 304 of the article 300 is shown in FIG. 3 with a perspective view of a first side 306, with a perspective view of part of a second side 307 shown in FIG. 4.

The article 300 comprises the aerosol generator 304. The aerosol generator 304 is configured to generate an aerosol from the aerosol generating material 302 upon operation of the aerosol provision system 100, as will be described in detail below.

The aerosol provision system 100 is elongate, extending along a longitudinal axis. The aerosol provision system 100 has a proximal end 102, which will be closest to the user (e.g. the user's mouth) when in use by the user to inhale the aerosol generated by the aerosol provision system 100, and a distal end 104 which will be furthest from the user when in use.

The proximal end may also be referred to as the “mouth end”. The aerosol provision system 100 accordingly defines a proximal direction, which is directed towards the user when in use. Further, the aerosol provision system 100 likewise defines a distal direction, which is directed away from the user when in use. The terms ‘proximal’ and ‘distal’ as applied to features of the system 100 will be described by reference to the relative positioning of such features with respect to each other in a proximal-distal direction along a longitudinal axis.

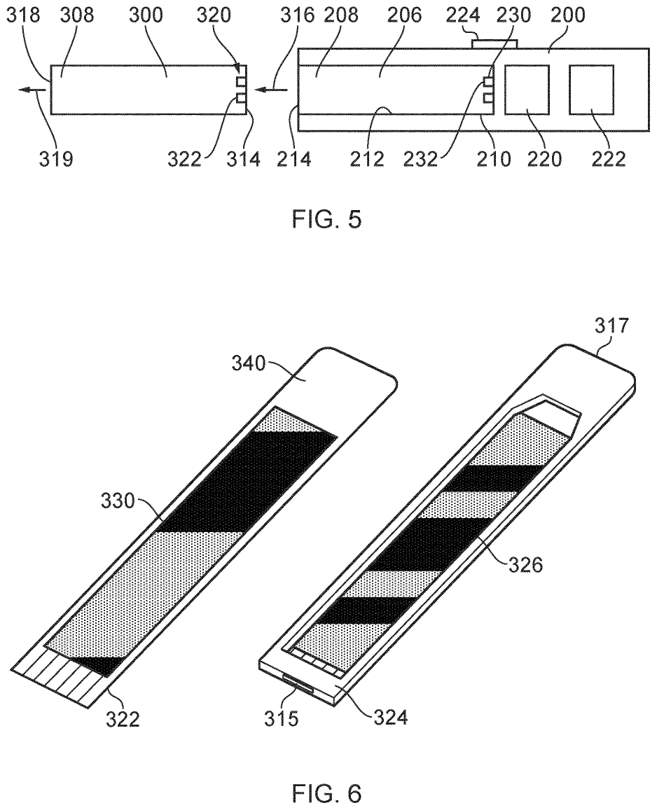

The article 300 is received by the aerosol provision device 200. The configuration of the article 300 and the aerosol provision device 200 may vary. In the present embodiment, the aerosol provision device 200 comprises a device body 202. The device has a housing 204 enclosing components of the device 200. A device chamber 206, as shown in FIG. 5, is configured to receive a portion of the article 300. A proximal end 308 of the article protrudes from the device 200 when the article 300 is received in the device chamber 206. A receptacle 208 defines the chamber 206. The receptacle 208 comprises a receptacle base 210 and a receptacle peripheral wall 212. The configuration of the receptacle 208 may vary in dependence on the configuration of the article 300.

One or more user-operable control elements 224, such as a button or switch, which can be used to operate the aerosol provision system 100 may be provided on the aerosol provision device 200. For example, a user may activate the system 100 by pressing the control element 224. The one or more user-operable control elements may be omitted. In embodiments, the aerosol provision system 100 is operated by another user action, for example puff activated by a user drawing air through the system.

The aerosol provision device 200 comprises an opening 214 at the proximal end, leading into the device chamber 206. The opening 214 is provided in one end, through which the article 300 can be inserted. In embodiments, the article 300 may be fully or partially inserted into the device 200. The configuration of the device 200 may vary, for example the opening may be in a longitudinal side wall of the device 200, and/or may be closed by another feature of the device 200 during use. In the present configuration, the article 300 defines a mouthpiece 310 at the proximal end 308. In embodiments, the device 200 defines the mouthpiece. The user places their mouth over the mouthpiece during use.

The device 200 defines the longitudinal axis along which an article 300 may extend when inserted into the device 200. The opening 214 is aligned on the longitudinal axis.

The aerosol provision device 200 comprises a power source 220. The power source 220 may be a battery, for example a rechargeable battery. The device 200 also comprises a control circuit 222, acting as a controller, comprising a processor and a memory.

As discussed in detail below, a heating system 110 is configured to heat the aerosol generating material 302 of an article 300. The article 300 in embodiments is a consumable, and is interchangeable with other articles 300. The heating system 110 comprises the aerosol generator 304. The heating system 110 comprises other components of the aerosol provision system 100 including components of the article 300 and the aerosol provision device 200, for example the power source 220 and the control circuit 222.

The aerosol generator 304 forms part of the article 300. The aerosol generator 304 comprises a heating arrangement 312 configured to heat aerosol generating material 302, for example at least one of a film and a gel to generate an aerosol. The aerosol generating material may be referred to as aerosolisable material.

The heating arrangement 312 is a resistive heating arrangement. The resistive heating arrangement comprises a plurality of heating elements as described below. Each heating element is a resistive heating element, as described in detail below. In such arrangements the heating system 110 comprises a resistive heating generator including components to heat the heating arrangement 312 via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement 312 comprises electrical contacts for supplying electrical current to the resistive material. The provision of a resistive heating arrangement 312 allows for a compact arrangement. Resistive heating provides an efficient configuration.

In the use of the aerosol provision system 100, air is drawn into an air inlet 314 of the article 300, as indicated by arrow 316. The air inlet 314 is in a distal end of the article 300. In embodiments, the air inlet 314 may have a different configuration, for example in the side. The air flow to the air inlet 314 of the article 300 may be defined, for example by at least one of an air path through the device 200, an air path external to the device 200, and an air path between the device 200 and the article 300. An aerosol generated by the aerosol generator 304 exits the article at an aerosol outlet 318, as indicated by arrow 319. In embodiments the aerosol outlet 318 is in the mouthpiece of the article 300, such that the aerosol is drawn directly from the article 300 into the mouth of a user of the system 100.

In some example embodiments, the aerosol provision system comprises two main components, namely a control section forming a reusable part and a consumable section forming a replaceable or disposable part which may be referred to as a replaceable or disposable article or cartridge. As described herein, the aerosol provision device 200 forms a control section and the article 300 forms the consumable section. In the use of the aerosol generating system, the control section and the consumable part may be releasably connected at an interface. The consumable part may be removable and replaceable, for example when the consumable part is used, with the control section being re-used with a different consumable part.

The aerosol provision system 100 as shown is provided by way of example only and is highly schematic. Different aerosol generating devices and other devices may be used in example implementations of the principles described here. For example, in some example embodiments, air is drawn into an air inlet in the control section, passes through the interface, and exits the consumable part.

As shown schematically in FIG. 5, and described in detail below, the article 300 has an article electrical contact configuration 320. The electrical contact configuration 320 in embodiments is formed by the aerosol generator 304. The electrical contact configuration 320 comprises heater electrical contacts 322. The heater electrical contacts 322 may also be known as heater or article contacts. The aerosol provision device 200 comprises an electrical connector 230. The electrical connector 230 comprises connector electrical contacts 232. The connector electrical contacts 232 may also be known as connector or device contacts. The article electrical contact configuration 320 is configured to electrically communicate with the device electrical connector 230.

The configuration of the article 300 may vary. The article 300 comprises a body 324. The body 324 is hollow. The body 324 defines a flow path 326 (refer to FIG. 6) through the article 300. The flow path 326 extends between the air inlet 314 and the aerosol outlet 318. The flow path 326 is defined by an internal space in the article along which air and/or aerosol can flow. The flow path 326 is defined in the body 324. The or each aerosol generator 304 bounds the flow path 326. The aerosol generating material 302 is exposed to the flow path 326. The aerosol generating material 302 is exposed in the internal space. The internal space in embodiments comprises two or more chambers.

The air inlet 314 comprises an opening 315. The opening 315 is formed in the body 324. In embodiments, the opening is formed in another component of the article 300, for example the aerosol generator 304 or another wall feature. The aerosol outlet 318 comprises an outlet opening 317. The outlet opening 317 is formed in the body 324. In embodiments, the outlet opening 317 is formed in another component of the article 300, for example the aerosol generator 304 or another wall feature.

As shown in FIG. 6, the article 300 comprises two aerosol generators 304 forming an aerosol generator arrangement. The number of aerosol generators 304 may differ. Each aerosol generator 304 comprises aerosol generating material 302. The aerosol generating material 302 is exposed to the flow path 326. In embodiments the article 300 comprises a single aerosol generator 304. One of the aerosol generators 304 will be described in detail, with such detail being applicable to one or more further aerosol generators 304 in embodiments.

The or each aerosol generator 304 and the body 324 are formed in a stacked configuration. In embodiments, other arrangements such as a tubular arrangement of the article are envisaged. In such tubular arrangements the aerosol generator 304 defines a tubular configuration. Tubular may include circular cross-sectional and other polygonal shapes.

In embodiments, as shown in the Figures, the article 300 has a flat configuration. That is, wherein an exterior of the article has a length, a width perpendicular to the length, and a depth perpendicular to each of the length and the width, wherein the length is greater than or equal to the width, and wherein the width is greater than the depth. Other configurations are envisaged.

FIG. 6 is a partially exploded perspective view of the article 300, with an aerosol generator 304 shown inverted from an assembled orientation and in a spaced relationship with other components. The article 300 comprises a first one of the aerosol generator 302, the body 324 and a second one of the aerosol generator. The body 324 spaces the first and second aerosol generators 304. The first and second aerosol generators 304 close the internal space defined by the body 324 along which air and/or aerosol can flow. The aerosol generating material 302 of the first and second aerosol generators 304 face each other and is exposed to the internal space. When assembled, the first and second aerosol generators 304 sandwich the body 324. In the embodiment of FIG. 6 at least, the first and second aerosol generators 304 and the body have equal plan areas. In embodiments, one or more of the first and second aerosol generators 304 and the body 324 has a greater length and/or width. In embodiments, one of the first and second aerosol generators 304 is replaced by a blank panel. The body 324 comprises a body layer. The body may comprise a plurality of body layers. The body layers may be formed in a stack and arranged to define features of the article 300, such as the air inlet 314 and aerosol outlet 318.

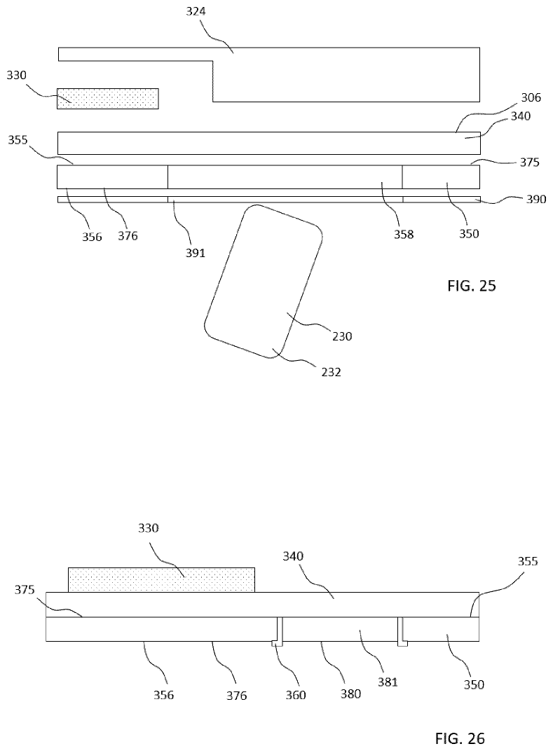

A wrap 390 encircles the article 300 and forms part of the article 300, refer for example to FIG. 25. The wrap 390 is a sheet. The wrap 390 acts as a fixed sleeve. The or each aerosol generator 304 protrudes from the wrap 390 at a distal end. Exposed electrical contact regions 323 of the heater contacts 322 are exposed at the distal end. Other configurations are envisaged, for example at least one exposed electrical contact region 323 may additionally or alternatively be defined along a minor longitudinal face or edge of the article 300, and on a major face of the article defined by the aerosol generator 304.

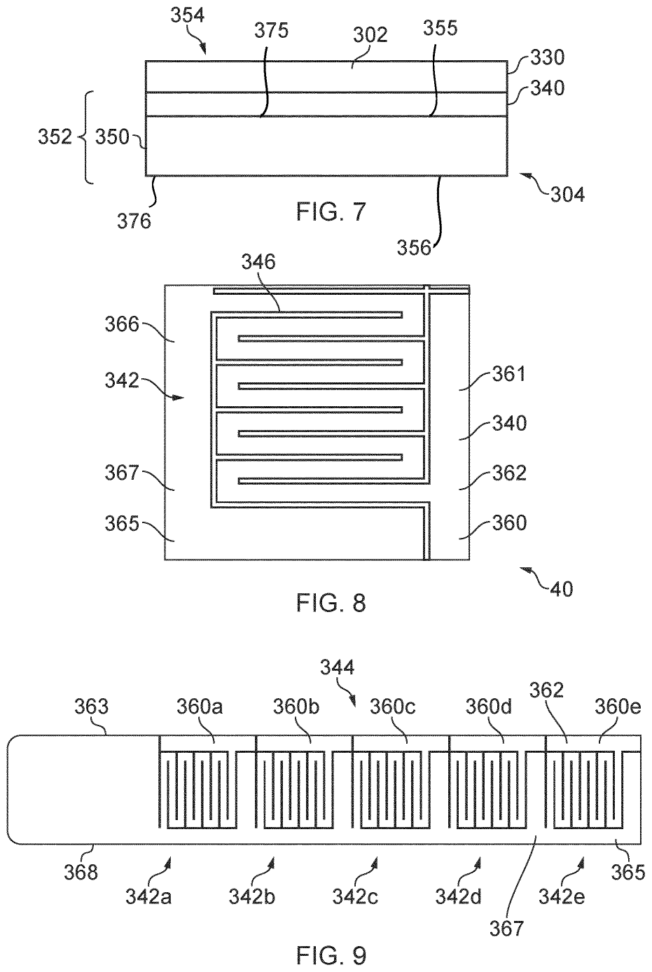

The aerosol generator 304 is schematically shown in cross section in FIG. 7. The aerosol generator 304 is an implementation of the aerosol generator 304 of the aerosol provision system 100 described above.

The aerosol generator 304 comprises an aerosol generating layer 330. The aerosol generating layer is also known as an aerosolisable layer. The aerosol generating layer 330 comprises the aerosol generating material 302. The aerosol generator 304 comprises a resistive heating layer 340. The resistive heating layer 340, in embodiments, is formed as an electrically conductive layer. The aerosol generating layer 330 is on the resistive heating layer 340. The aerosol generating layer 330 is in direct contact with the resistive heating layer 340. In embodiments, the aerosol generating layer 330 is in indirect contact with the resistive heating layer 340. The resistive heating layer 340 may in embodiments comprise a coating. As described in detail below, the resistive heating layer 340 comprises a plurality of resistive heating elements 342, for example as shown in FIGS. 8 and 9. The or each resistive heating element 342 forms at least a portion of an electrically conductive path between a pair of the electrical contacts 322. The or each resistive heating element 342 provides the electrically conductive path for resistive heating of at least of portion of the aerosol generating material 302 to generate an aerosol. The aerosol generating material 302 is, in embodiments, in the form of a film or a gel.

The resistive heating layer 340 is formed as an electrically conductive layer. This layer in embodiments takes the form of at least one of a metal layer, such as an aluminium layer, or a non-metallic material, such as graphene. The resistive heating layer 340 is in the form of a foil, for example an aluminium foil.

The aerosol generator 304 comprises a support 350. The support 350 in embodiments comprises a paper or card material. The support 350 provides structural support for the aerosol generator 304. The resistive heating layer 340 is on the support 350. The support 350 is configured as a support layer. As shown in FIG. 7, in the aerosol generator 304, the resistive heating layer 340 is sandwiched between the support 350 and the aerosol generating layer 330.

The support 350 is electrically insulative. The resistive heating layer 340 and the support layer 350 define a substrate 352. The substrate 352 supports the aerosol generating layer 330.

The article 300 comprises a laminate 354 comprising the resistive heating layer 340 and the support layer 350. In embodiments, the laminate 354 comprises the aerosol generating layer 330. The aerosol generating layer 330 may be formed as a contiguous configuration, or may be formed from discrete portions. The discrete portions may comprise one or more of dots, strips, spirals, or other shapes.

In embodiments, the aerosol generating layer 330 comprises an aerosol-generating film. In embodiments, the aerosol generating layer 330 comprises a plurality of aerosol-generating films. In embodiments, the aerosol-generating film comprises a plurality of aerosol-generating film regions. Such plurality of aerosol-generating films and/or plurality of aerosol-generating film regions may have different properties, for example at least one of different compositions, thicknesses, density, active substances and/or flavours, one or more aerosol-former materials, and optionally one or more other functional material.

One or more of the aerosol generating layer 330, resistive heating layer 340 and the support layer 350 may comprise a further layer. For example, the support layer 350 may comprise a backing layer or an intermediate layer. The support layer 350 in embodiments is omitted.

FIG. 8 shows one of the resistive heating elements 342. The resistive heating layer 340 comprises a plurality of resistive heating elements 342. In embodiments, the resistive heating layer 340 comprises a single resistive heating element 342.

The plurality of heating elements 342 are formed in an array 344 as shown in FIG. 9. Other configurations are envisaged.

The resistive heating element 342 comprises a resistive heating path. The resistive heating path is formed by an electrically conducting path. The resistive heating resistive heating path is non-straight. The resistive heating path is convoluted. The configuration of the resistive heating path may vary. The electrical resistance of the heating element 342 may be dependent on the nature of the resistive heating path in the conductive layer, for example the length, width, thickness and arrangement of the path. The resistive heating element 342 extends between a first type of electrical contact 360 and a second type of electrical contact 365. The first type of electrical contact 360 is configured to provide a positive contact and the second type of electrical contact 365 is configured to provide a negative contact. Electrical current flows between the first type of electrical contact 360 and the second type of electrical contact 365 through the path. The contact arrangement may be reversed. The first and second types of electrical contacts are heater electrical contacts 322. The first and second types of electrical contacts 360, 365 form at least part of the article electrical contact configuration 320.

The meandering or serpentine nature of the path of the resistive heating element 342 is such that the electrical resistance of the path is increased when compared with a straight path between the first and second type of electrical contacts.

The resistive heating layer 340 comprises a first type of electrical track 361 extending from the resistive heating element 342. The first type of electrical track 361 comprises the first type of electrical contact 360. The electrical contact 360 of the first type is configured to electrically connect with the device electrical connector 230. The first type of electrical contact 360 comprises a first type of exposed contact region 362. The first type of exposed contact region 362 is exposed on the article for direct connection with the device electrical connector 230.

The resistive heating layer 340 comprises a second type of electrical track 366 extending from the resistive heating element 342. The second type of electrical track 366 comprises the second type of electrical contact 365. The electrical contact 365 of the second type is configured to electrically connect with the device electrical connector 230. The second type of electrical contact 365 comprises a second type of exposed contact region 367. The second type of exposed contact region 367 is exposed on the article 300 for direct connection with the device electrical connector 230.

As discussed in detail below, the conducting path of the resistive heating element 342 in embodiments is created by defining at least one electrically insulative barrier 346 in the resistive heating layer 340. In embodiments, the electrically insulative barrier 346 is formed by cutting electrically insulative barrier restrictions (i.e. electrically insulating portions), such as gaps, channels or slots into a sheet formed of electrically conductive material to form the resistive heating layer 340. In embodiments, the resistive heating layer 340 is preformed to define the or each resistive heating element 342 and then applied to the support 350. In embodiments, the resistive heating layer 340 is applied to the support 350, and the or each resistive heating element 342 then defined in the resistive heating layer 340. The or each restive heating element 342 defining the resistive heating layer 340 may be a printed heater. The insulative barrier may be an air gap. In embodiments, the insulative barrier is a filled gap, for example filled with an insulative material. The barrier defines a barrier to electrical conduction across the barrier.

The or each resistive heating element 342 defining the resistive heating layer 340 may be formed by a cutting action. Cutting may include die cutting. The resistive heating element may be formed by an action applied to the resistive heating layer only. In embodiments, the resistive heating element may be formed by an action applied to the resistive heating layer and the support layer, for example an action of cutting the resistive heating layer and the support layer.

The at least one electrically insulative barrier 346 defines the first and second types of electrical track 361, 366.

In some embodiments, the tracks of the or each resistive heating element 342 have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The or each resistive heating element 342 may have overall dimensions of the order of 10 mm×10 mm. Other dimensions are possible in other example embodiments. By forming the or each resistive heating element 342 of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

As shown in FIG. 9, the resistive heating layer 340 is formed into the plurality of resistive heating elements, indicated generally by the reference numerals 342a, 342b, 242c, 342d and 342e. Each of the resistive heating elements 342a-342e extends from a respective one of the first type of electrical contact, indicated generally by the reference numerals 360a, 360b, 360c, 360d and 360e to a single second type of electrical contact 365. The number of electrical contacts may vary. As such, each resistive heating element 342a-342e extends between a discrete first type of electrical contact and a common second type of electrical contact.

Each of the resistive heating element 342a-342e provides an electrically conductive path for resistive heating of a portion of the aerosol generating material 302 to generate an aerosol at the respective portion of the aerosol generator 304.

The separate first type 360a-360e of electrical contacts enable an electric current to be individually provided to each of the plurality of resistive heating elements 342a-342e. The heating of different zones of the aerosol generating layer 330 can be controlled. For example, an aerosol generator may be provided with five aerosol generating zones. The resistive heating layer 340 allows each of those zones to be activated separately. Accordingly, for example, five puffs of aerosol may be generated from a single consumable incorporating a single aerosol generator 304, and ten puffs of aerosol may be generated from a single consumable incorporating two aerosol generators 304.

In the example resistive heating layer 340, the plurality of first type of electrical contacts 360a-360e (for example a positive electrical connection) are provided and a single second type of electrical contact 365, for example a negative electrical connection is provided. This is not essential to all implementations. For example, multiple contacts of the second type could be provided. In embodiments each resistive heating element 342a-342e comprises a corresponding one of the first type of electrical contact 360 and a corresponding one of the second type of electrical contact 365.

In the shown embodiment of FIG. 9 of the resistive heating layer 340, the first type of electrical contacts 360a-360e are arranged on a first edge 363 of the resistive heating layer 340 and the second type of electrical contact 365 is arranged on a second edge 368 of the resistive heating layer 340. This may allow for convenient connection of electrical power, but, of course, many other configurations are possible, some of which are discussed further below.

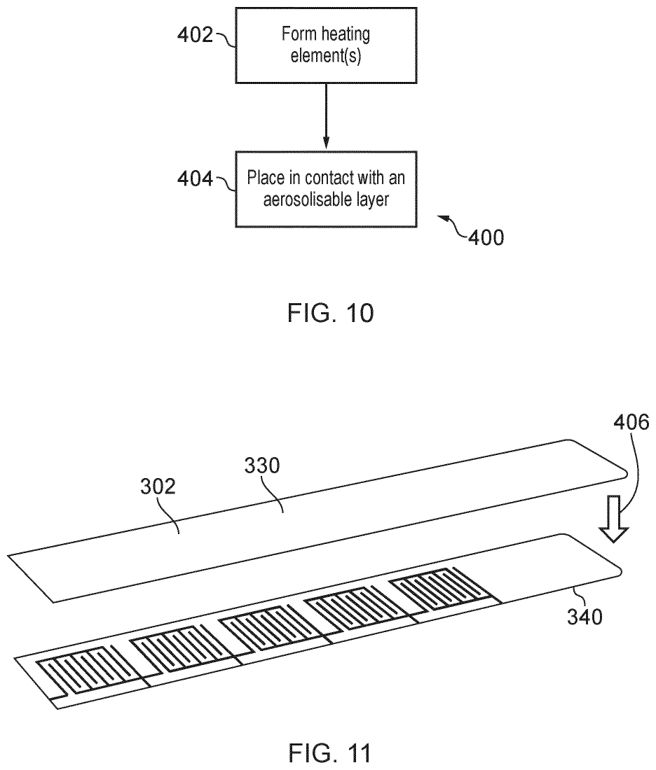

FIG. 10 is a flow chart showing part of a method of forming an aerosol generator 304 or an algorithm, indicated generally by the reference numeral 400, in accordance with an example embodiment.

The method or algorithm 400 starts at operation 402, where a resistive heating layer is formed into one or more heating elements (e.g. a plurality of heating elements), wherein each resistive heating element extends from an electrical contact of a first type to an electrical contact of a second type. In use, the or each heating element may be used to provide an electrically conductive path for resistive heating of a portion of an aerosol generating material to generate an aerosol. The formation of the or each resistive heating element may occur prior to or post application of the resistive heating layer on a support, where a support is present. The resistive heating layer may be adhered to the support, or mounted or formed on the support in a different configuration.

At operation 404, the formed resistive heating layer is placed in contact with the aerosol generating layer, wherein said aerosol generating layer incorporates aerosol generating material.

FIG. 11 shows the aerosol generator 304 being formed in accordance with an embodiment. The aerosol generating material 302 is formed on the resistive heating layer 340 by depositing aerosol generating material, for example by spraying, painting, dispensing or in some other way. The aerosol generating layer 330 is disposed on resistive heating layer 340 as indicated by the arrow 406, in an example implementation of the operation 404.

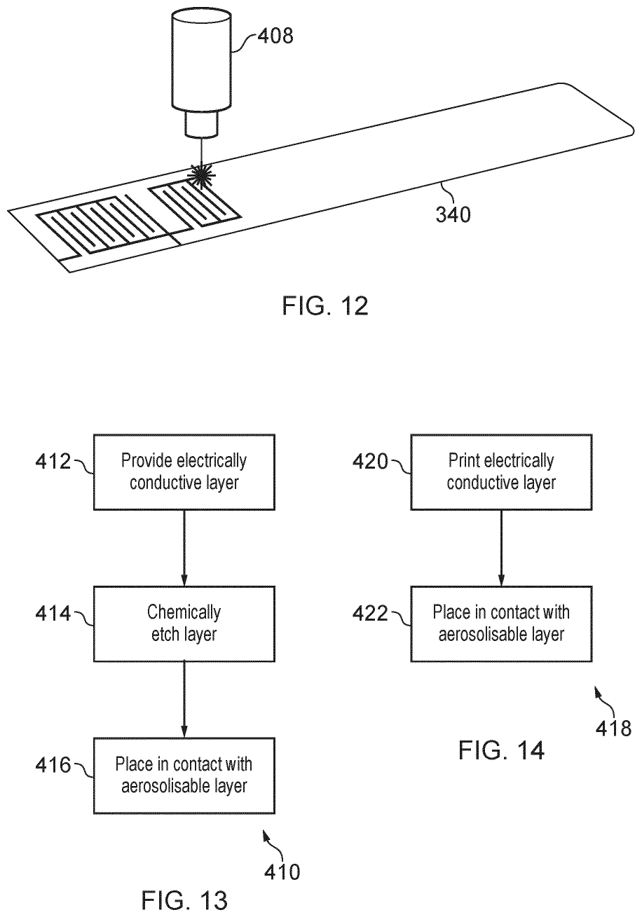

FIG. 12 shows the resistive heating layer 340 being formed in accordance with an example embodiment. The resistive heating layer 340 is in the process of being cut using a laser cutter 408. The cutting of the resistive heating layer 340 can be used to form the paths of the heating elements described herein. The use of the laser cutter 408 (or some other cutting process) is not the only method by which the resistive heating layer 340 described herein may be generated. Some example methods are described below.

FIG. 13 is a flow chart showing part of a method of forming an aerosol generator 304 or an algorithm, indicated generally by the reference numeral 410. The method or algorithm 410 starts at operation 412, where the resistive heating layer is provided. At operation 414, one or more of the resistive heating elements are formed in the resistive heating layer by chemically etching the resistive heating layer. The operations 412 and 414 are an example implementation of the operation 402 of the method 400 described above. The aerosol generating material is then disposed on the resistive heating layer, thereby implementing the operation 404 described above.

FIG. 14 is a flow chart showing part of a method of forming an aerosol generator 304 or an algorithm, indicated generally by the reference numeral 418. The method or algorithm 418 starts at operation 420, where one or more heating elements are formed, at last in part, by printing a resistive heating layer. The operation 420 is therefore an example implementation of the operation 402 of the algorithm 400 described above. The aerosol generating material is then disposed on the resistive heating layer, thereby implementing the operation 404 described above.

The cutting, etching and printing methods described above are provided by way of example; other additional or alternative methods are also possible. For example, a so-called “hot foiling” approach could be used in which a heating element is made out of a resistive heating layer, and then assembled/bonded onto a support. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

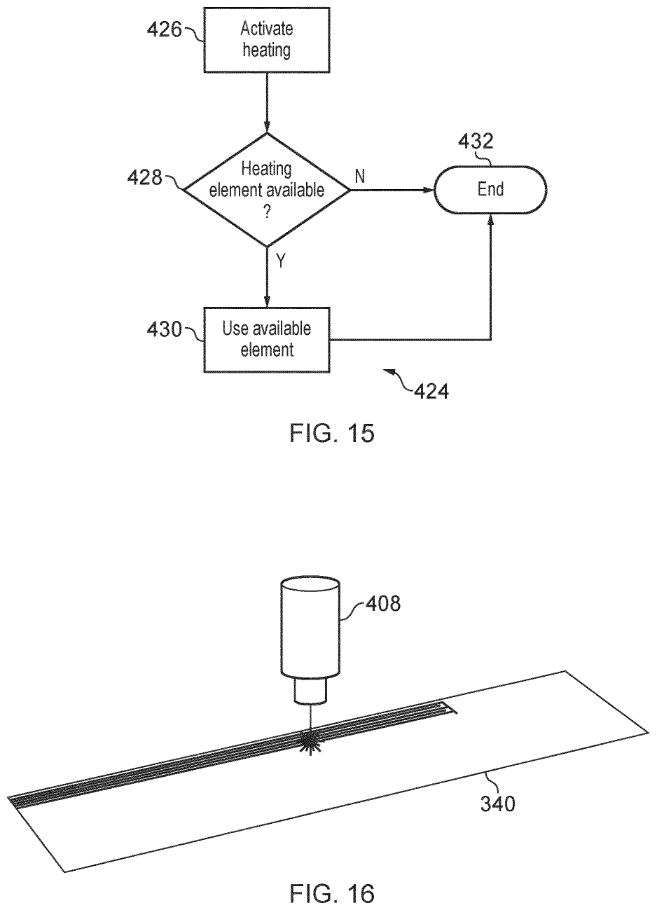

FIG. 15 is a flow chart showing method of operation or an algorithm, indicated generally by the reference numeral 424, in accordance with an example embodiment. The method or algorithm 424 may, for example, be implemented using any of the aerosol generators described herein. The method or algorithm 424 is initiated when an instruction to activate heating is received in an instance of operation 426. In response to the instruction to activate heating, a determination is made (in operation 428) regarding whether a heating element is available. As discussed above, a plurality of heating elements may be provided. The operation 428 may involve determination which of the heating elements have been used and/or the corresponding available aerosol generating material used up.

If a heating element is available, the algorithm moves to operation 430, where an available heating element is used. As discussed above, heating elements may be individually controllable, for example by providing electrical power to individual heating elements. Once the operation 430 is complete, the algorithm terminates at operation 432. If, at operation 428, a determination is made that no heating elements are available, for example because all heating elements have been used, then the algorithm terminates at operation 432. This may mean that a consumable part being used to implement the algorithm 424 needs to be replaced.

FIG. 16 shows the resistive heating layer 340 being formed in accordance with an embodiment. The resistive heating layer 340 is being cut using the laser cutter 408, although other methods could be used, such as chemical etching or printing, as discussed above. The cutting of the electrically conductive layer 340 forms the heating elements as described herein.

In the embodiment of FIG. 16, the paths cut are linear paths, extending along the length of the electrically conductive layer 120.

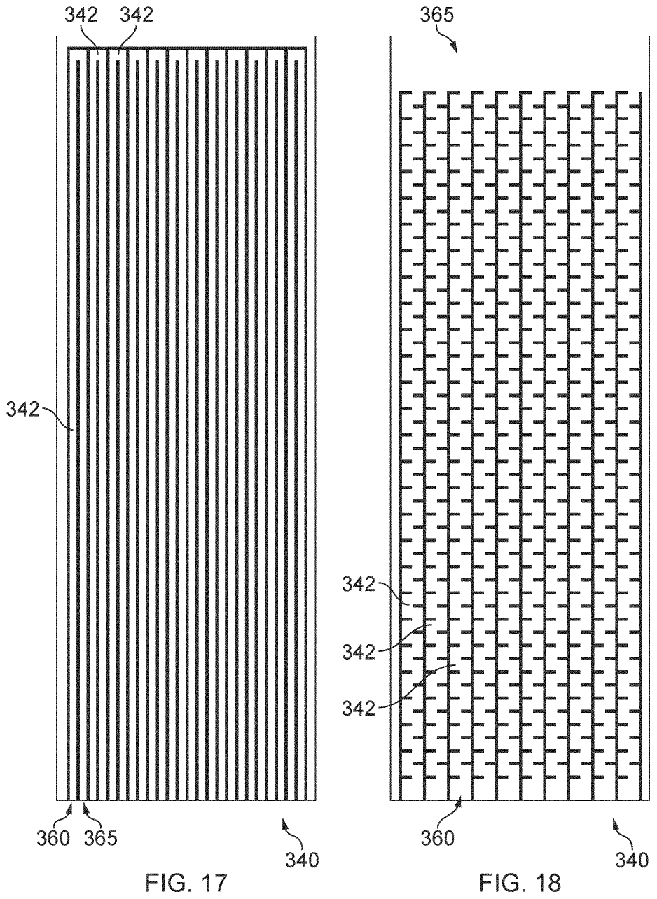

FIG. 17 shows another embodiment of the resistive heating layer 340. The resistive heating layer 340 may be formed using the laser cutter 408 described above, or some similar device or another method. The resistive heating layer 340 comprises a plurality of resistive heating elements 342, each resistive heating element 342 being a linear heating element comprising a conducting path extending along a length of the resistive heating layer 340. Each resistive heating element 342 extends from one of the first type of electrical contact 360, for example a positive electrical connection to one of the second type of electrical contact 365, for example a negative electrical contact. In such an embodiment, both types of electrical contact are provided at the same end of the resistive heating layer 340 and are provided next to each other. In such an arrangement that there is free from a common second type of electrical contact as is some other embodiments; instead, each heating element has separate first and second types of electrical contacts.

FIG. 18 shows another embodiment of the resistive heating layer 340. The resistive heating layer 340 may be formed using the laser cutter 408 described above, or some similar device or another method. The resistive heating layer 340 comprises a plurality of heating elements 342, each heater element 342 being a linear heating element comprising a conducting path extending along a length of the resistive heating layer 340. Each resistive heating element 342 extends from one of the first type of electrical contact 360, for example a positive electrical connection to the second type of electrical contact 365, for example a negative electrical contact. In such an embodiment, the different types of electrical connection are provided at the opposite ends of the resistive heating layer 340 and a common second type of electrical contact is provided. Although a linear path is provided, an increase in the electrical resistance may be provided by means of providing a crenelated path, acting as a convoluted path. Note that the paths of any other embodiments described herein could also be crenelated.

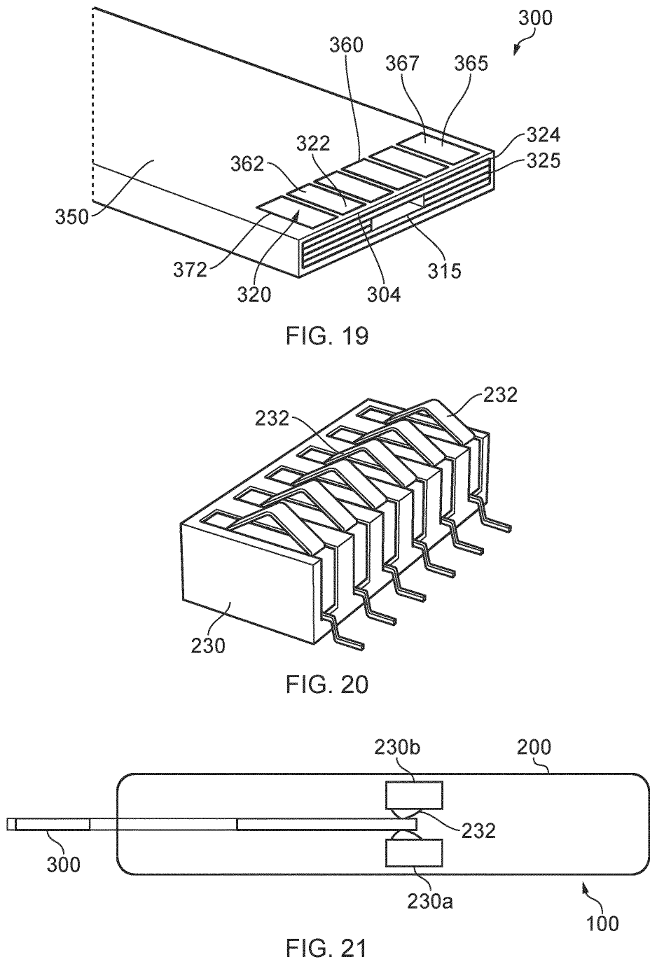

FIG. 19 shows the distal end of the article 300. As shown, the body 324 comprises a plurality of body layers 325. The body layers 325 are arranged in a stack of body layers 325. The body layers 325 form a laminate. The body layers 325 in embodiments are card layers. Other suitable materials may be used. The body layers 325 are configured to define features of the article 300. At least one body layer in embodiments comprises a gap defining the air inlet 315. The gap defines the opening 314.

The aerosol generator 304 comprises the resistive heating layer 340. The resistive heating layer 340 comprises the resistive heating elements 342, the first type of electrical contacts 360, for example providing positive electrical connections to each of a plurality of heating elements 342 and a single second type of electrical contact 365, for example providing a common negative electrical connection to the plurality of heating elements 342. The first and second types of electrical contacts 360, 365, namely the heater contacts 322, together form at least part of the article electrical contact configuration 320 of the aerosol generator 304.

The resistive heating elements 342 are in contact with the aerosol generating layer 330 on an inward surface 341 of the resistive heating layer 340, refer for example to FIG. 24. The resistive heating layer 340 at least partly defines the first side 306 of the aerosol generator 304 as shown in FIG. 3. The heater contacts 322 are on an outward surface 343 of the resistive heating layer 340, refer for example to FIG. 24. The heater contacts 322 are exposed on the second side 307 of the aerosol generator 304. The outward surface 343 defines part of the second side of the aerosol generator 304. The heater contacts 322 are exposed so that they are able to be brought into contact with the device electrical connector 230. The heater contacts 322 are exposed on an opposing side of the resistive heating layer 340 to the resistive heating elements 342. Other configurations are envisaged.

The heater contacts 322 are exposed on an opposing side of the support layer 350 to the resistive heating layer 340 itself. The support layer 350 in embodiments is free from a fold. This helps simplify manufacture of the aerosol generator 304.

The support layer 350 defines the first type of exposed contact region 362. The support layer 350 defines the second type of exposed contact region 367. The heater contacts 322 of the first type of electrical track 361 and the second type of electrical track 366 are exposed on the second side of the resistive heating layer 340. Portions of the first type of electrical track 361 and the second type of electrical track 366 extend on the first side of the resistive heating layer 340.

The aerosol provision device 200 comprises a plurality of connector electrical contacts 232 of the electrical connector 230. The configuration of the device connector 230 is dependent on the configuration of the heater contacts 322 of the aerosol generator 304. In embodiments, such as the aerosol generator as shown in FIG. 19, the aerosol generator 300 comprises a plurality of accessible heater contacts 322 including a plurality of the first type of heater contact 360 and one of the second type of heater contact 365. The article 300 comprises another set of heater contacts 322 on the opposing side of the article 300 corresponding to the second aerosol generator 304.

FIG. 20 shows a device connector 230 of the aerosol provision device 200 used in some embodiments. The connector 230 has separate connector electrical contacts 232 for connection with the heater contacts 322.

FIG. 21 schematically shows the aerosol provision system 100. The system 100 comprises the article 300 and aerosol provision device 200, both shown in block diagram. The device 200 comprises first and second connectors 230a and 230b.

The connectors 230a and 230b enable the aerosol provision device 200 to provide regulated or controlled electrical voltages and/or currents to the various first and second type of heater contacts 360, 365 of the aerosol generator 304 when the article 300 is inserted into the aerosol provision device 200. The aerosol provision device 200 may comprise a connector arrangement configured to provide electrical power to the connectors 230a, 230b. The aerosol provision device 200 may, for example, operate the method as described above.

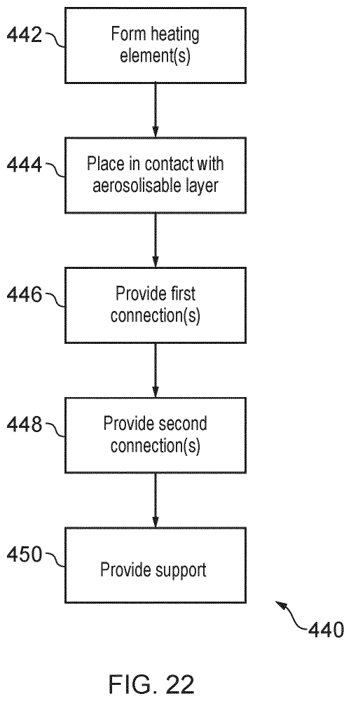

FIG. 22 is a flow chart showing a method of forming an aerosol generator 304 or an algorithm, indicated generally by the reference numeral 440, in accordance with an example embodiment.

The method or algorithm 440 starts at operation 442, where a resistive heating layer is formed into at least one resistive heating element, the or each heating element providing an electrically conductive path for resistive heating of at least a portion of an aerosolisable material to generate an aerosol. Example heating elements that may be formed in the operation 442 are described elsewhere in this document.

At operation 442, an aerosol generating material is applied and/or formed on the resistive heating layer 340.

The operations 442 and 444 of the method or algorithm 440 are similar to (and may be identical to) the operations 402 and 404 of the method or algorithm 400 described above.

In operation 446 at least one first type of electrical contact is provided on the resistive heating layer. The method of formation may be any of the methods described above. In operation 448 at least one second type of electrical contact is provided on the resistive heating layer. The method of formation may be any of the methods described above.

The first and second types of electrical contact may be formed along or proximal a single edge of the resistive heating layer. The first and second types of electrical contact may be formed along or proximal to different edges of the resistive heating layer.

The first types of electrical contact (e.g. positive connection(s)) may be provided along a first edge of the resistive heating layer. The second types of electrical contact (e.g. negative electrical connection(s)) may be provided along a second edge of the resistive heating layer. The operations 446 and 448 could be performed in a different order, or at the same time. Moreover, the operations 446 and 448 could be performed together with the operation 442.

At operation 450, a support 350 is provided. The resistive heating layer 340 is provided on a first side 355 of the support 350 between the aerosol generating layer 330 and the support 350. At least one first type of electrical contact 360 and the second type of electrical contact 365 being is accessible from a second side 356 of the support 350.

In embodiments, operation 450 of the method 400 comprises forming an opening 358 in the support 350 such that the at least one of the first type of electrical contact 360 and the second type of electrical contact 365 is accessible from the second side 356 of the support 350 through the opening 358 such that the aerosol generator as described in reference to any embodiment of the aerosol generator above is formed.

The method 400 may further comprise forming the at least one of the first type of electrical contact 360 and the second type of electrical contact 365 to extend at least partially through the support 350.

As seen in FIGS. 7, 23, 24 and 25, for example, the support 350 comprises the first side 355 and the second side 356. The resistive heating layer 340 is on the first side 355 of the support 350 and is between the support 350 and the aerosol generating layer 330. The support 350 comprises a first surface 375 on the first side 355 and a second surface 376 on the second side 356. The second side 356 of the support 350 defines an exposed side of the article 300 when assembled.

The support 350 and the resistive heating layer 340 are free from a fold. The resistive heating layer 340 and the support 350 are planar bodies. In embodiments, a fold is formed in one or both of the support 350 and the resistive heating layer 340. By restricting folds in the resistive heating layer 340, the resistivity of the features of the resistive heating layer 340 are more reliably controlled.

The first type of electrical contact 360 and the second type of electrical contact 365 are accessible from the second side 356 of the support 350. In some examples, all of or some of the plurality of first type of electrical contacts 360 may be accessible from the second side 356 of the support. Additionally or alternatively, all of or some of the plurality of second type of electrical contacts 365 may be accessible from the second side 356 of the support 350.

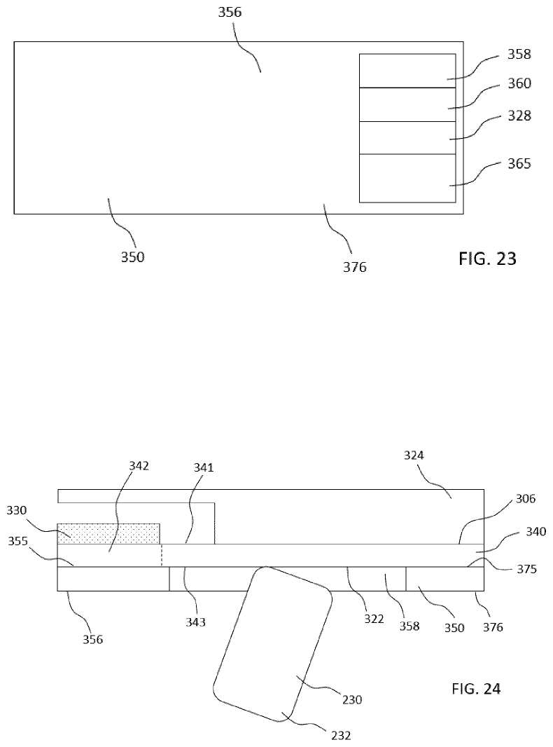

The first type of electrical contact 360 and the second type of electrical contact 365 are exposed from the second side 356 of the support 350. The support 350 defines at least one exposed contact region of the first type of electrical contact 360 or the second type of electrical contact 365. The first side 306 of the aerosol generator 304 is covered by other components of the article 300, such as the body 324 of the article 300, as shown schematically in FIGS. 6 and 23.

“Exposed” is taken to mean that the electrical contact is able to be brought into electrical contact with another component on the second side 356 of the support 350. Accordingly, the device electrical connector contact 232 can be connected to it. The exposed contact region is one of an exposed contact region of a first type 362 or the exposed contact region of the second type 367. In examples, the support 350 defines discrete exposed contact regions of each of the first type of electrical contact 360 and the second type of electrical contact 365.

The first type of electrical contact 360 and the second type of electrical contact 365 are configured to be connected to the device electrical connectors 230 such that device 200 is able to supply electrical power to the resistive heating layer 340. The first type of electrical contact 360 and the second type of electrical contact 365 are configured to be connected to the device electrical connector contacts 232 to provide an electrical connection between the device 200 and the first type of electrical contact 360 and the second type of electrical contact 365. Electric current is supplied to each of the resistive heating elements 342 from the power source 220 through the electrical connection between the device 200 and the first type of electrical contact 360 and the second type of electrical contact 365.

As seen in FIGS. 23, 24 and 25, the support 350 comprises an opening 358 such that the first type of electrical contact 360 and the second type of electrical contact 365 are accessible from the second side 356 of the support 350. The first type of electrical contact 360 and the second type of electrical contact 365 are accessible through the support 350. The opening 358 extends between the first surface 375 and the second surface 376 of the support 350. In embodiments, the opening 358 may comprise an aperture in the support 350 that surrounds the first type of electrical contact 360 and the second type of electrical contact 365 and enables access from the second surface 376 of the support 350 only. In embodiments, the opening 358 may be a cutaway in the support 350 that extends from an edge of the support 350 and enables access to the first type of electrical contact 360 and the second type of electrical contact 365 from the side of the support 250 and from the second surface 376 of the support 350. In embodiments, the opening 358 may be formed with the support 350 during manufacture. In embodiments, the opening 358 may be formed, for example by drilling, milling or cutting. In embodiments, the wrap 390 extends over the support 350. The wrap 390 overlies the second surface 376, as shown in FIG. 25. In such an arrangement the wrap 390 comprises wrap opening 391. The wrap opening 391 aligns with the opening 358 in the support 350.

In embodiments, the wrap 390 comprises a plurality of layers, the wrap opening 391 being formed through the plurality of layers. In embodiments, the support 350 comprises a wrap, and/or the wrap acts as the support 350.

In embodiments, the opening 358 may be cylindrical, rectangular or any other shape.

The opening 358 is configured to receive at least a portion of the device electrical connector 230 such that the device electrical connector 230 is at least partially disposed within the opening 358. When at least a portion of the device electrical connector 230 is received in the opening 358, the device electrical connector contact 232 contacts the at least one of the first type of electrical contact 360 and the second type of electrical contact 365 as seen in FIGS. 24 and 25.

The opening 358 defines a common opening between at least two exposed contact regions such that both of the first type of electrical contact 360 and the second type of electrical contact 365 can be accessed through the common opening. In embodiments, the support 350 may comprise a plurality of openings 358. The support 350 may comprise one opening 358 for each of the first type of electrical contacts 360 and the second type of electrical contacts 365. In embodiments, the support 350 may comprise a single opening 358 for all of the first type of electrical contacts 360 and a second opening 358 for all of the second type of electrical contacts.

In embodiments, the openings 358 may be spaced regularly along the support 350. The openings 358 may be spaced along the length of the support 350 i.e. repeating along the longest dimension of the support. The openings 358 may be spaced along the width of the support 350 i.e. repeating along the second longest dimension of the support. In embodiments, the openings 358 may be placed along the sides of the support 350.

As seen in FIG. 26, the at least one of the first type of electrical contact 360 and the second type of electrical contact 365 extends at least partially through the support 350. In embodiments, the at least one of the first type of electrical contact 360 and the second type of electrical contact 365 extends entirely through the support 350 as seen for example in FIG. 26. In embodiments, the first type of electrical contact 360 and the second type of electrical contact 365 extends through the support 350. In embodiments, the first type of electrical contact 360 and the second type of electrical contact 365 extends entirely through the support 350. By extending at least partially through the support 350, the at least one of the first type of electrical contact 360 and the second type of electrical contact 365 is accessible from the second side 356 of the support 350. In embodiments, the at least one of the first type of electrical contact 360 and the second type of electrical contact 365 extends entirely through the support 350 and is exposed on the second side 356 of the support.

The support 350 comprises a path 380 through which the at least one of the first type of electrical contact 360 and the second type of electrical contact 365 extends. The path 380 is formed by an aperture 381. In embodiments, the path 380 is formed by a hole or an opening in the support 350. In embodiments, the aperture 381 extends through the support 350 and through the resistive heating layer 340.

The at least one of the first type of electrical contact 360 and the second type of electrical contact 365 extends around at least a part of a sidewall of the aperture 381. The at least one of the first type of electrical contact 360 and the second type of electrical contact 365 extends around a rim of the aperture. In embodiments, the at least one of the first type of electrical contact 360 and the second type of electrical contact 365 extends only around the sidewalls of the aperture 381 or around the sidewall and around at least one of a first and second rim of the aperture 381. In embodiments, the at least one of the first type of electrical contact 360 and the second type of electrical contact 365 extends fully through the support 350. In embodiments, the at least one of the first type of electrical contact 360 and the second type of electrical contact 365 extends through the support 350 and beyond the second side 356 of the support 350. In embodiments, the at least one of the first type of electrical contact 360 and the second type of electrical contact 365 extends fully through the support 350, beyond the second side 356 of the support and on the second surface 376 of the support 350. The at least one of the first type of electrical contact 360 and the second type of electrical contact 365 may overlap the second side 356 of the support 350. In embodiments, the at least one of the first type of electrical contact 360 and the second type of electrical contact 365 extends partially through the support 350.

The at least one of the first type of electrical contact 360 and the second type of electrical contact 365 comprises a conductive coating. In embodiments, the conductive coating may comprise a conductive ink. The conductive ink is in liquid form when applied, thus making it easier to apply to the path 380, for example to the sidewalls of the aperture, rims of the aperture and the second surface of the support 350.

In embodiments, one or more of the device electrical connector contacts 232 may be attached to the at least one of the first type of electrical contact 360 and the second type of electrical contact 365 to provide an electrical connection between the device electrical connector 230 and the resistive heating layer 340. The device electrical connector contact 232 may be attached to the conductive coating.

An aerosol provision system 500 is also disclosed. The aerosol provision system comprises an article 300 and an aerosol provision device 200. In embodiments, the article 300 and the aerosol provision device 200 may be as described above.

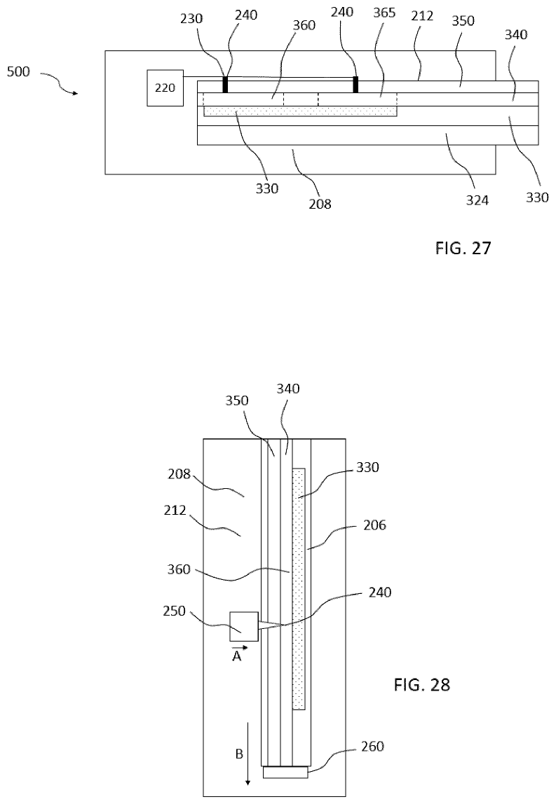

As seen in FIG. 27, the device 200 is configured to receive at least a portion of the article 300. The device 200 receives a part of the article 300 such that a portion of the article 300 protrudes from the device 200. In embodiments, the device 200 may receive the entire article 300.

The article 300 comprises an aerosol generating layer 330 which comprises aerosol generating material 302. The article 300 also comprises a resistive heating layer 340 which comprises a resistive heating element 342 configured to heat at least a portion of the aerosol generating material 302 such that the aerosol generating material 302 generates an aerosol. The aerosol generating layer 330 is on the resistive heating layer 340. The article 300 also comprises a body 324.

The article 300 further comprises at least one of a first type of electrical contact 360 and at least one of a second type of electrical contact 365. In embodiments, the at least one of first type of electrical contact 360 and the second type of electrical contact 365 may be as described above. The resistive heating element 342 forms an electrically conductive path between the first type of electrical contact 360 and the second type of electrical contact 365.

The article 300 further comprises a support 350. The resistive heating layer 340 is disposed on a first side 355 of the support 350 such that it is sandwiched between the aerosol generating layer 330 and the support 350. At least one of the first type of electrical contact 360 and the second type of electrical contact 365 is accessible from a second side 356 of the support 350.

The device 200 comprises a device electrical connector 230 that receives power from the power source 220. In embodiments, the device 200 may comprise a plurality of device electrical connectors 230. The device electrical connector 230 is configured to connect with the at least one of the first type of electrical contact 360 and the second type of electrical contact 365. In embodiments, the device may comprise a device electrical connector 230 that is configured to be connected to the first type of electrical contact 360 and a second device electrical connector 230 that is configured to be connected to the second type of electrical contact 365. The device electrical connector 230 comprises a device connector electrical contact 232 that is configured to connect to the at least one of the first type of electrical contact 360 and the second type of electrical contact 365. The device connector electrical contact 232 is made of an electrically conductive material.

The device electrical connector 230 comprises a piercing element 240 as seen for example in FIGS. 27 and 28. The piercing element 240 is configured to pierce a feature of the article 300. The feature comprises the support 350. In embodiments, the feature may comprise the support 350 and the resistive heating layer 340. In embodiments, the feature may comprise the body 324. In embodiments, the feature may comprise the aerosol generating layer 330. The piercing element 240 is configured to pierce the support 350 such that it contacts the at least one of the first type of electrical contact 360 and the second type of electrical contact 365 through the support 350. Accordingly, the piercing element 240 acts as the device connector electrical contact 232. In contacting the at least one of the first type of electrical contact 360 and the second type of electrical contact 365, the piercing element 240 electrically contacts the at least one of the first type of electrical contact 360 and the second type of electrical contact 365. In embodiments, each of the device connector electrical contacts 232 is a piercing element.

The piercing element 240 comprises a pin. The piercing element 240 comprises electrically conductive material. In embodiments, the piercing element 240 may comprise a metal. The piercing element 240 is configured to penetrate the support 350 to contact the at least one of the first type of electrical contact 360 and the second type of electrical contact 365. In embodiments, the piercing element 240 may be configured to penetrate the resistive heating layer 340 to contact the at least one of the first type of electrical contact 360 and the second type of electrical contact 365. In embodiments, the plurality of device electrical connectors 230 may each comprise a piercing element 240. As shown in FIG. 27, the device 200 comprises one piercing element 240 for each of the at least one of the first type of electrical contact 360 and the at least one of the second type of electrical contact 365. In embodiments, each piercing element 240 may be configured to make an electrical connection with one of the first type of electrical contact 360 or one of the second type of electrical contact 365. In embodiments, each piercing element 240 may be configured to pierce the support 350 such that they contact a first type of electrical contact 360 or a second type of electrical contact 365.

The device comprises a receptacle 208 that is configured to receive the article 300. The article 300 is partially received by the receptacle 208 such that at least a portion of the article 300 protrudes from the receptacle. In embodiments, the article 300 may be fully received by the receptacle 208. When the article 300 is received in the receptacle 208 the piercing element 240 penetrates the article 300 such that an electrical connection is formed between the piercing element 240 and at least one of the first type of electrical contact 360 and the second type of electrical contact 365.

The piercing element 240 is movable into piercing engagement with the article 300. The piercing element 240 is positioned on a movable plate 250 that is disposed in the receptacle 208 and the movable plate 250 is configured to be movable toward the article 300 relative to the device 200 when the article 300 is received in the receptacle 208. The movable plate 250 is disposed in a receptacle peripheral wall 212 or in a receptacle base 210. The movable plate 250 is configured to automatically move toward the article (in direction A) in response to the article 300 being received in the receptacle. In embodiments, the receptacle 208 may further comprise a sensor that is configured to detect that the article 200 is received in the receptacle 208. In response to detecting that the article 300 is received in the receptacle 208, the sensor may send a signal to a processor to indicate that the article 300 is received in the receptacle 208. In response to receiving the signal, the processor may send an actuation signal to an actuator which is mechanically connected to the movable plate 250. In response to receiving the actuation signal, the actuator moves the movable plate 250 toward the article 300 that is received in the receptacle 208.

The receptacle 208 comprises a pressure plate 260 as seen in FIG. 28. When received in the receptacle 208, the article 300 depresses the pressure plate 260 (in direction B). The pressure plate 260 is linked to the moveable plate 240. In embodiments, the pressure plate may be mechanically connected to the movable plate 240 by a bar linkage mechanism. The bar linkage mechanism may be configured to transfer force exerted on the pressure plate 260 to the movable plate 250. When the pressure plate 260 is depressed, the movable plate 250 is moved towards the article 300 which is disposed in the receptacle 208 such that the piercing element 240 is brought into piercing engagement with the support 350.

In embodiments, the device 200 comprises a button, acting as a user operable actuator. The user may actuate the button to cause the movable plate 250 to move toward the article 300 when the article is received in the receptacle 208 such that the piercing element 240 is brought into piercing engagement with the support 350. The button may be electrically linked to a motor which is configured to actuate the piercing element 240. Should the user wish to remove the article 300 from the receptacle, the user may actuate the button a second time to cause the piercing element 240 to move away from the article 300.

In embodiments, a securing element is disposed in the receptacle 208 which secures the article 300 in place when the article 300 is received in the receptacle 208. The piercing element 240 moves towards the securing element. When the article 300 is received in the receptacle 208, the movable plate 250 moves toward the securing element such that the article 300 is sandwiched between the movable plate 250 and the securing element. The securing element provides a resistive force opposing the movement of the movable plate 250 such that the piercing element is brought into piercing engagement with the support 350.

In embodiments, the securing element is movable. The securing element moves simultaneously with the movable plate 250 to secure the article 300 in place in the receptacle 208. The securing element may move in a substantially opposite direction to that of the movable plate 250. The securing element and the movable plate 250 may be formed as reciprocating jaws. The movable plate 250 and the securing element may move following the actuation of a button by the user as described above, and/or in response to a pressure plate 260 being depressed as described above.

In embodiments, the article 300 may be movable into piercing engagement with the piercing element 240. The piercing element 240 may be fixed to the receptacle 208. The piercing element 240 may be disposed on the receptacle base 210 or the receptacle peripheral wall 212. The piercing element 240 may be fixed to the receptacle 208 such that it will pierce the article 300 when the article is received in the receptacle 208. The piercing element 240 may extend into the device chamber 206 that is defined by the receptacle 208. The article 300 may occupy the device chamber 206 when the article 300 is received in the receptacle 208. When the article 300 is inserted into the receptacle 208, the article 300 may be pushed on to the piercing element 240 such that the piercing element 240 is in piercing engagement with the article 300.

The piercing element 240 provides electrical power to the resistive heating layer 340.

A blank for forming an aerosol generator 304 of an article 300 for an aerosol provision device 200 is also disclosed. The aerosol generator 304 may be an aerosol generator 304 as described in any of the previous embodiments. The blank comprises an aerosol generating layer 330 which comprises aerosol generating material 302. The aerosol generating material 302 may be in the form of a gel. The blank further comprises a resistive heating layer 340 which comprises a resistive heating element 342. The resistive heating element 342 is configured to heat at least a portion of the aerosol generating material 302 to generate an aerosol.

The resistive heating layer 340 is cut using a laser cutter as previously described. The resistive heating layer 340 is formed into a plurality of resistive heating elements 342, although the number may differ and may be one. A plurality of a first type of the electrical contact 360 (e.g. positive electrical contact) are provided on the electrically conductive layer 340. One or more of a second type of electrical contact 365 (e.g. negative electrical contact) is also provided on the resistive heating layer 340. In embodiments the contacts are spaced from the edges. As discussed above, each heating element of the plurality of heating elements 342 extends from an electrical contact of the first type 360 to an electrical contact of the second type 365.

The cutting of the resistive heating layer 340 by the laser cutter 408 forms the paths of the or each heating element 342. As discussed above, laser formation or some other cutting process is not the only method by which the resistive heating layer 340 described above may be generated. Some example alternative methods include chemical etching, die cutting and printing.

The blank comprises a support 350 and the resistive heating layer 340 is on a first side 355 of the support between the aerosol generating layer 330 and the support 350. The blank comprises an opening 358 in the support 350 that enables access to at least one of the first type of electrical contact 360 and the second type of electrical contact 365.

In some embodiments of the different arrangements of aerosol generators and articles described above the aerosol generating material is formed in a configuration other than as an aerosol generating layer. The aerosol generating material in embodiments is in the form of an aerosol generating segment. The aerosol generating segment generally comprises a solid material. Such a solid material may be shredded tobacco. The aerosol generating material, arranged as an aerosol generating segment for example, may comprise a plurality of individual pieces of aerosol generating material. The aerosol generating material may be individual pieces of tobacco material. In embodiments, the aerosol generating material comprises a plurality of strips, beads or pellets. In embodiments the aerosol generating segment is a plug of material.

The aerosol generating segment in embodiments comprises a body of material. The aerosol generating material is a non-liquid. In such an embodiment, the body of material comprises a rod of aerosol generating material, for example a tobacco rod. For example, the body of material may comprise shredded tobacco material. The body of material may be formed into a rod. In some embodiments, the body of material comprises cut rag tobacco that is formed into a rod. The aerosol generating material may comprise tobacco material. The aerosol generating material may comprise extruded tobacco. The aerosol generating material may comprise reconstituted tobacco.

The aerosol generating material, formed as a solid material, may comprise nicotine. The aerosol generating material may comprise, consist of, or essentially consist of, tobacco. In embodiments, the aerosol generating material is free from tobacco.

In embodiments of any of the above, the heating of the article provides a relatively constant release of volatile compounds into an inhalable medium. In an embodiment of the above, the aerosol generating segment is a plug of material. The article may comprise a mouth end section. A tubular element may be located between the aerosol generating material and the mouth end section. The article may comprise a ventilation area in the mouth end section. The mouth end section may define a mouthpiece configured to be placed between a user's lips.

In embodiments of any of the above described articles, the or each resistive heating element is configured to heat substantially the entire aerosol generating material. The aerosol generating segment in embodiments is at least substantially cylindrical. In embodiments, the aerosol generating segment is at least partially wrapped by the resistive heating layer. In embodiments, the resistive heating element extends in the aerosol generating segment. The resistive heating element may extend around the aerosol generating segment. In embodiments, the resistive heating element encircles the aerosol generating segment. In some arrangements at least a portion of the flow path through the article is through the aerosol generating segment. The aerosol generating segment may define part of the air path. In embodiments, the first type of electrical contact and the second type of electrical contact are exposed from the aerosol generating segment.

The aerosol generating material may comprise tobacco material as described herein, which includes a tobacco component. In the tobacco material described herein, the tobacco component may contain paper reconstituted tobacco. The tobacco component may also contain leaf tobacco, extruded tobacco, and/or bandcast tobacco. The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco. In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generator of an article for an aerosol provision device, the aerosol generator comprising:
aerosol generating material;
a resistive heating layer comprising a resistive heating element configured to heat at least a portion of the aerosol generating material to generate an aerosol;
the aerosol generating material being on the resistive heating layer;
a first type of electrical contact;
a second type of electrical contact;
wherein the resistive heating element is at least a portion of an electrically conductive path between the first type of electrical contact and the second type of electrical contact; and
a support, wherein the resistive heating layer is on a first side of the support between the aerosol generating material and the support;
wherein at least one of the first type of electrical contact and the second type of electrical contact is accessible from a second side of the support.

2. The aerosol generator of claim 1, wherein the resistive heating layer is free from a fold.

3. The aerosol generator of claim 1, wherein the support is electrically insulative.

4. The aerosol generator of claim 1, comprising an aerosol generating layer comprising aerosol generating material, wherein the aerosol generating layer is on the resistive heating layer.

5. The aerosol generator of claim 1, wherein the at least one of the first type of electrical contact and second type of electrical contact is accessible from a second side of the support.

6. The aerosol generator of claim 1, comprising an opening in the support so that the at least one of the first type of electrical contact and the second type of electrical contact is accessible from the second side of the support.

7. The aerosol generator of claim 6, wherein the opening is configured to receive at least a portion of a device electrical connector of an aerosol provision device.

8. The aerosol generator of claim 6, wherein the support defines an exposed contact region of at least one of the first type of electrical contact and the second type of electrical contact.

9. The aerosol generator of claim 1, wherein the at least one of the first type of electrical contact and the second type of electrical contact extends at least partially through the support.

10. The aerosol generator of claim 9, comprising a path in the support through which at least one of the first type of electrical contact and the second type of electrical contact extends.

11. The aerosol generator of claim 10, wherein the path comprises an aperture through the support, and the at least one of the first type of electrical contact and the second type of electrical contact extends around a sidewall of the aperture.

12. The aerosol generator of claim 11, wherein the aperture extends through the resistive heating layer.

13. The aerosol generator of claim 9, wherein the at least one of the first type of electrical contact and the second type of electrical contact comprises a conductive coating.

14. The aerosol generator of claim 9, wherein the at least one of the first type of electrical contact and the second type of electrical contact overlaps the second side of the support.

15. A method of forming an aerosol generator of an article for an aerosol provision device, the method comprising:
providing a resistive heating layer;
providing aerosol generating material on the resistive heating layer, wherein the resistive heating layer comprises a resistive heating element configured to heat at least a portion of the aerosol generating material to generate an aerosol;
providing a first type of electrical contact;
providing a second type of electrical contact;
wherein the resistive heating element is at least a portion of an electrically conductive path between the first type of electrical contact and the second type of electrical contact;
providing a support;
providing the resistive heating layer on a first side of the support between the aerosol generating material and the support;
wherein at least one of the first type of electrical contact and the second type of electrical contact is accessible from a second side of the support.

16. An aerosol provision system comprising:
an article and an aerosol provision device configured to receive at least a portion of the article, the article comprising:
aerosol generating material;
a resistive heating layer comprising a resistive heating element configured to heat at least a portion of the aerosol generating material to generate an aerosol;
the aerosol generating material being on the resistive heating layer;
a first type of electrical contact;
a second type of electrical contact;
wherein the resistive heating element is at least a portion of an electrically conductive path between the first type of electrical contact and the second type of electrical contact; and
a support, wherein the resistive heating layer is on a first side of the support between the aerosol generating material and the support;
wherein at least one of the first type of electrical contact and the second type of electrical contact is accessible from a second side of the support.

17. The aerosol provision system of claim 16, wherein the aerosol provision device comprises a device electrical connector configured to connect with the at least one of the first type of electrical contact and the second type of electrical contact.

18. The aerosol provision system of claim 17, wherein the device electrical connector comprises a piercing element configured to pierce a feature of the article.

19. The aerosol provision system of claim 18, wherein the feature of the article comprises the support, and the piercing element is configured to pierce the support to electrically contact the at least one of the first type of electrical contact and the second type of electrical contact.

20. (canceled)
